(19) United States
(12) Patent Application Publication
(10) Pub. No.: US 2013/0171539 A1
(43) Pub. Date: Jul. 4, 2013

(54) TUBULAR SOLID OXIDE FUEL CELL MODULE AND METHOD OF MANUFACTURING THE SAME

(71) Applicants: Hong Ryul Lee, Gyunggi-do (KR); Bon Seok Koo, Seoul (KR); Jai Hyoung Gil, Seoul (KR); Sung Han Kim, Seoul (KR); Kyong Bok Min, Gyunggi-do (KR); Eon Soo Lee, Gyeongsangbuk-do (KR); Han Wool Ryu, Seoul (KR); Jong Ho Chung, Gyunggi-do (KR); Jong Sik Yoon, Seoul (KR)

(72) Inventors: Hong Ryul Lee, Gyunggi-do (KR); Bon Seok Koo, Seoul (KR); Jai Hyoung Gil, Seoul (KR); Sung Han Kim, Seoul (KR); Kyong Bok Min, Gyunggi-do (KR); Eon Soo Lee, Gyeongsangbuk-do (KR); Han Wool Ryu, Seoul (KR); Jong Ho Chung, Gyunggi-do (KR); Jong Sik Yoon, Seoul (KR)

(73) Assignee: SAMSUNG ELECTRO-MECHANICS CO., LTD., Gyunggi-do (KR)

(21) Appl. No.: 13/425,480

(22) Filed: Mar. 21, 2012

(30) Foreign Application Priority Data
Dec. 28, 2011 (KR) 1020110144762

(51) Int. Cl. H01M 8/02; H01M 4/66; H01M 8/10; H01M 2/20

(52) U.S. Cl. 429/482; 429/535

(57) ABSTRACT

Disclosed herein is a tubular solid oxide fuel cell module including an anode layer, an electrolyte layer, a cathode layer divided into two parts or more, a conductive mesh structure and a conductive wire, and a method of manufacturing the same. The tubular solid oxide fuel cell is advantageous in that the cathode is divided into two parts or more, so that the moving distance of electric charges is decreased, with the result that resistance loss can be minimized, thereby increasing the efficiency of collecting electric charges.

### CROSS REFERENCE TO RELATED APPLICATION

This application claims the benefit of Korean Patent Application No. 10-2011-0144762, filed Dec. 28^{th} 2011, entitled “Tubular solid oxide fuel cell module and producing method thereof”, which is hereby incorporated by reference in its entirety into this application.

### BACKGROUND OF THE INVENTION

1. Technical Field

The present invention relates to a tubular solid oxide fuel cell module and a method of manufacturing the same.

2. Description of the Related Art

Since general fuel cells have various output ranges and uses, appropriate fuel cells can be selected depending on the purpose thereof. Among such fuel cells, solid oxide fuel cells (SOFCs) are attracting considerable attention as fuel cells for distributed power generation, industries and households because they are advantageous in that it is relatively easy to control the position of an electrolyte, in that there is no danger of an electrolyte being exhausted because the position of an electrolyte is fixed, and in that their life cycles are long because they have strong corrosion resistance.

Further, solid oxide fuel cells (SOFCs), which are fuel cells operating at a high temperature of 600˜1000° C., have many advantages that they have the highest efficiency of various types of fuel cells, that they hardly cause environment pollution and that they can accomplish combined power generation without a fuel reforming apparatus.

Generally, a solid oxide fuel cell is configured such that an electrolyte is disposed at the center thereof and electrodes (cathode and anode) are disposed at both sides thereof. Here, an electrolyte must be dense such that gas does not pass therethrough, and must have high oxygen ion conductivity although it does not have electron conductivity. In contrast to this, electrodes must be porous such that gas easily diffuses thereinto, and must have high electron conductivity. As such, when the difference in partial pressure of oxygen between an anode and a cathode is maintained by injecting hydrogen-containing fuel gas into the anode and injecting air into the cathode with the electrolyte being disposed between the anode and the cathode, a drive force for moving oxygen through the electrolyte is formed.

Since an electrolyte has only ion conductivity without electron conductivity, oxygen ions formed by receiving electrons from a cathode pass through an electrolyte film, provide electrons to an anode, and then react with hydrogen gas to produce water vapor. When oxygen and hydrogen are continuously supplied to cause the reaction, electrons flow into an external collector through the electrodes, and, at this time, electrical energy is generated and then used. The collector serves to collect electric current generated under a predetermined voltage, and, in this case, the performance of the collector can be increased when the loss of resistance of the collector must be minimized.

Meanwhile, since such a solid oxide fuel cell cannot obtain a sufficient voltage only with a unit cell, if necessary, it can be used in the form of a stack of unit cells. Solid oxide fuel cells are classified into two types of a tubular solid oxide cell and a flat solid oxide cell.

Among these two types of solid oxide cells, it is evaluated that the power density of a stack of the tubular solid oxide cell is somewhat lower than that of the flat solid oxide cell, but that the power density of the entire system of the tubular soli oxide cell is similar to that of the flat solid oxide cell. Further, the tubular solid oxide cell is advantageous in that unit cells constituting a stack can be easily sealed, it has high resistance to thermal stress, and the mechanical strength of the stack is high, thereby manufacturing a large-area solid oxide cell. Further, tubular solid oxide cells are classified into two kinds of a tubular solid oxide cell using a cathode as a support and a tubular solid oxide cell using an anode as a support. Meanwhile, in a conventional collector, electric charges are collected by winding a cathode with a wire made of nickel (Ni), silver (Si) or the like.

At the time of evaluating the performance of a solid oxide fuel cell wound with a silver wire to collect electric charges, when electric current is measured while increasing or decreasing a voltage after applying a predetermined voltage, or when a voltage is measured while increasing or decreasing electric current after applying a predetermined electric current, a performance curve can be obtained as shown in FIG. 1. Such a performance curve is an important barometer for evaluating a solid oxide fuel cell, and the performance of a solid oxide fuel cell is influenced by the loss of resistance of the silver wire used as a collector.

Korean Unexamined Patent Publication No. 2011-0023359 discloses a solid oxide fuel cell wound with a wire, wherein an anode and a cathode are respectively coated with conductive ink, and a conductive mesh structure and a conductive wire are sequentially fixed on the coating layer. Here, generally, the anode is made of nickel (Ni), and the cathode is made of silver (Ag). In the case of the anode, electric charges are collected by providing a conductive material having high stability at a high temperature, such as nickel or the like, into the cell, and, in the case of the cathode, electric charges are collected by winding the cell with a silver wire having high oxidation stability. In this case, electric charges generated from the cell move along a conducting wire connected to the collector. However, this solid oxide fuel cell is problematic in that electric charges move in the length direction of the cell, so the resistance loss thereof increases, thereby deteriorating the performance thereof.

### SUMMARY OF THE INVENTION

Thus, the present inventors found that the loss of resistance of a fuel cell could be minimized when a cathode of the fuel cell was divided into two parts or more. Based on this finding, the present invention was completed.

Accordingly, the present invention has been devised to solve the above-mentioned problems, and an object of the present invention is to provide a solid oxide fuel cell module which can minimize the loss of resistance of the fuel cell and maximize the output of the fuel cell by the divided cathode.

Another object of the present invention is to provide a solid oxide fuel cell module which can efficiently collect electric charges by sequentially applying conductive ink, a conductive mesh structure and a conductive wire onto the outer surface of a tubular solid oxide fuel cell and then sintering them.

In order to accomplish the above objects, an aspect of the present invention provides a tubular solid oxide fuel cell module, including: a tubular anode layer; an electrolyte layer formed on an outer surface of the tubular anode layer; a cathode layer formed on an outer surface of the electrolyte layer and divided into two parts or more in a length direction thereof; a conductive ink layer formed on an outer surface of the divided cathode layer; a conductive mesh structure surrounding an outer surface of the conductive ink layer, the conductive mesh structure having a curved inner surface corresponding to the outer surface of the conductive ink layer; and a conductive wire wound on an outer surface of the conductive mesh structure.

In the tubular solid oxide fuel cell module, the conductive mesh structure may have 10˜80 meshes.

Further, the conductive wire may be wound two times or three times per 1 cm length of the conductive mesh structure in a length direction of the conductive mesh structure.

Further, the conductive mesh structure may be made of any one selected from the group consisting of Fe, Cu, Ag, Al, Ni, Cr, and alloys thereof.

Further, the conductive ink layer and the conductive wire may be made of any one selected from the group consisting of Au, Pd, Ag, Pt, Ni, Ru, Rh, Ir, and alloys thereof.

Another aspect of the present invention provides a method of manufacturing a tubular solid oxide fuel cell module, including: providing a tubular anode layer; forming an electrolyte layer on an outer surface of the tubular anode layer; forming a cathode layer divided into two parts or more in a length direction thereof on an outer surface of the electrolyte layer; forming a conductive ink layer on an outer surface of the divided cathode layer; forming a conductive mesh structure surrounding an outer surface of the conductive ink layer, the conductive mesh structure having a curved inner surface corresponding to the outer surface of the conductive ink layer; and winding a conductive wire on an outer surface of the conductive mesh structure.

The method may further include: sintering the conductive wire after winding the conductive wire.

In the method, the sintering may be conducted at 800˜900° C.

Further, the conductive mesh structure may have 10˜80 meshes.

Further, the conductive wire may be wound two times or three times per 1 cm length of the conductive mesh structure in a length direction of the conductive mesh structure.

Further, the conductive mesh structure may be made of any one selected from the group consisting of Fe, Cu, Ag, Al, Ni, Cr, and alloys thereof.

Further, the conductive ink layer and the conductive wire may be made of any one selected from the group consisting of Au, Pd, Ag, Pt, Ni, Ru, Rh, Ir, and alloys thereof.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a graph showing the performance of a solid oxide fuel cell at the time of collecting electric charges;

FIG. 2A is a perspective view showing a tubular solid oxide fuel cell module according to an embodiment of the present invention;

FIG. 2B is a cross-sectional view of a part (fuel cell) of the tubular solid oxide fuel cell module of FIG. 2A; and

FIG. 3 is a schematic view showing an electric charge collecting method of the tubular solid oxide fuel cell module according to an embodiment of the present invention.

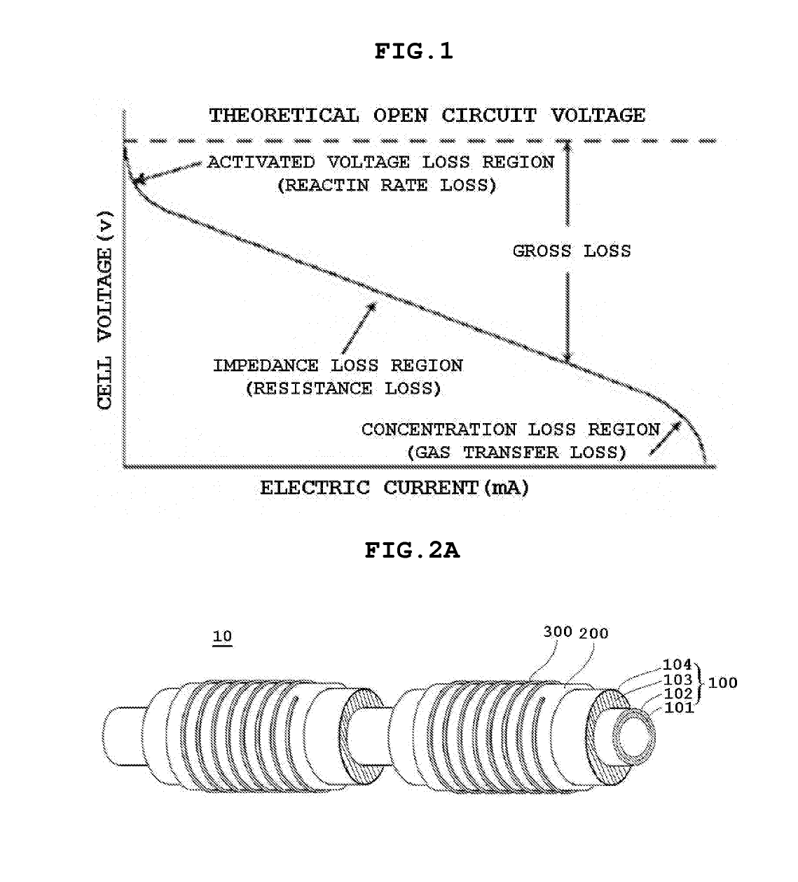

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

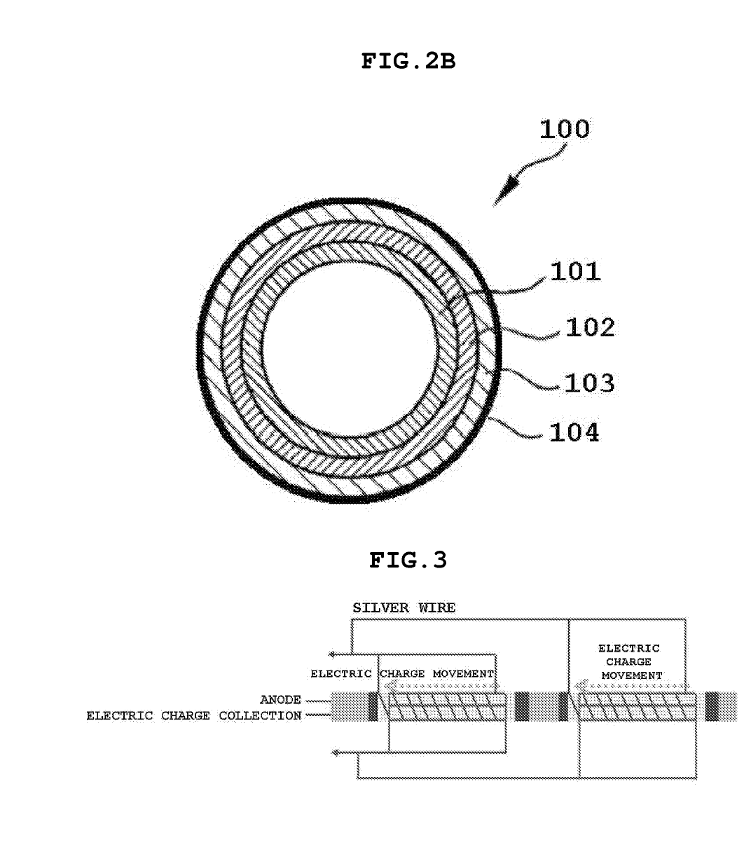

FIG. 2A is a perspective view showing a tubular solid oxide fuel cell module according to an embodiment of the present invention, and FIG. 2B is a cross-sectional view of a part (fuel cell) of the tubular solid oxide fuel cell module of FIG. 2A.

As shown in FIGS. 2A and 2B, a tubular solid oxide fuel cell module 10 according to an embodiment of the present invention includes a tubular anode layer 101, an electrolyte layer 102, a cathode layer 103, a conductive ink layer 104, a conductive mesh structure 200, and a conductive wire 300. More concretely, the tubular solid oxide fuel cell module 10 includes a tubular anode layer 101; an electrolyte layer 102 formed on the outer surface of the tubular anode layer 101; a cathode layer 103 formed on the outer surface of the electrolyte layer 102 and divided into two parts or more in the length direction thereof; a conductive ink layer 104 formed on the outer surface of the divided cathode layer 103; a conductive mesh structure 200 surrounding the outer surface of the conductive ink layer 104, the conductive mesh structure having a curved inner surface corresponding to the outer surface of the conductive ink layer 104; and a conductive wire 300 wound on the outer surface of the conductive mesh structure 200.

The tubular anode layer 101 serves to support a fuel cell 100, and may be made of a cermet of nickel and an oxide conductor. Nickel can exhibit high catalytic activity because it has high electron conductivity and adsorbs hydrogen and hydrocarbons. Further, nickel is generally used as an electrode material because it is cheaper than platinum. In the case of a solid oxide fuel cell operating at a high temperature, the tubular anode layer 101 may be made of a Ni/YSZ cermet which is obtained by sintering nickel oxide powder including 40˜60% of zirconia powder, but is not limited thereto.

It is preferred that the electrolyte layer 102, if possible, be thin in order to decrease a voltage drop attributable to resistance polarization because its ion conductivity is lower than that of a liquid electrolyte such as an aqueous solution or a molten salt. However, the electrolyte layer 102 easily forms gaps, pores or cracks. Therefore, a solid oxide electrolyte needs uniformity, compactness, heat resistance, mechanical strength, stability and the like in addition to ion conductivity. Examples of such solid oxide electrolytes may include, but are not limited to, YSZ (yttria stabilized zirconia), ScSZ (scandium stabilized zirconia), GDC, LDC and the like. The electrolyte layer 102 may formed by coating the outer surface of the anode layer 101 with the solid oxide electrolyte using slip coating or plasma spray coating and then sintering it at 1300˜1500° C.

The cathode layer 103 may be formed by coating the outer surface of the electrolyte layer 102 with a composition including LSM (strontium doped lanthanum manganite), LSCF ((La,Sr)(Co,Fe)O₃) and the like using slip coating or plasma spray coating and then sintering it at 1200˜1300° C. In the present invention, in order to minimize the resistance loss in the length direction of the cathode layer 102 at the time of collecting electric charges, the cathode layer 102 is divided into two parts or more to provide a structure-improved tubular solid oxide fuel cell module.

Referring to FIGS. 2A and 2B, the cathode layer 103 divided into two parts or more is applied onto the electrolyte layer 102, a conductive ink layer 104 is applied onto the divided cathode layer 103, the conductive ink layer 104 is surrounded by a conductive mesh structure 200, and then the conductive mesh structure 200 is wound with a conductive wire 300 to fabricate a fuel cell module 10. As such, when the fuel cell module 10 is fabricated by dividing only the cathode layer 103 into two parts or more, the moving distance of electric charges is decreased to minimize the deterioration of performance of the fuel cell module 10 attributable to resistance loss, and the conductive wires 300, wound on the divided parts thereof, are connected to each other at the final end thereof to efficiently collect electric charges.

Here, the conductive ink layer 104 is applied onto the outer surface of the divided cathode layer 103. The thickness of the conductive ink layer 104 is several micrometers (μm) to several millimeters (mm), and is determined in consideration of resistance. The conductive ink layer 104 may be made of any one of a metal, an alloy, a mixture of a metal and an alloy, and a mixture of a metal and a metal oxide. Considering conductivity, the conductive ink layer 104 may be made of any one of Au, Pd, Pt, Ag, Ni, Ru, Rh, Ir and alloys thereof.

Meanwhile, in order to produce an electric current, air must be transferred to the cathode layer 103. The fuel cell module 10 according to the present invention receives air from the conductive mesh structure 200 and then transfers the air to the cathode layer 103. In this case, the conductive mesh structure 200 may have 10˜80 meshes in consideration of the supply of air and the collection efficiency of electric charges, and may be made of any one selected from the group consisting of Fe, Cu, Ag, Al, Ni, Cr, alloys thereof and combinations thereof in consideration of the efficiency of a fuel cell and the strength thereof. Further, the conductive mesh structure 200 may be coated with an antioxidative material such as silver (Ag), conductive ceramic (MnCo, NiCl, LSC, LSCF) or the like in order to maintain durability at a high temperature.

The conductive wire 300 is located and fixed on the conductive mesh structure which adheres closely to the conductive ink layer 104 and surrounds the conductive ink layer 104 to collect the electric current generated from the tubular fuel cell 100. Here, the conductive wire 300 comes into contact with the surface of the conductive mesh structure 200. Due to the surface contact between the conductive mesh structure 200 and the conductive wire 300, contact resistance is decreased, with the result that the efficiency of collecting electric charges can be maintained or increased although the winding number of the conductive wire 300 is decreased.

The conductive wire 300 may be made of any one of a metal, an alloy, a mixture of a metal and an alloy, and a mixture of a metal and a metal oxide. Considering conductivity, the conductive wire 300 may be made of any one of Au, Pd, Pt, Ag, Ni, Ru, Rh, Ir and alloys thereof. Further, considering the efficiency of collecting electric charges, the conductive wire 300 may be wound two times or three times per 1 cm length of the conductive mesh structure 200 in the length direction of the conductive mesh structure 200.

FIG. 3 is a schematic view showing an electric charge collecting method of the tubular solid oxide fuel cell module according to an embodiment of the present invention. Referring to FIG. 3, the solid oxide fuel cell module of the present invention is configured such that the electrolyte layer is formed on the anode layer, the cathode layer divided into two parts or more is formed on the electrolyte layer, the conductive ink layer is applied onto the divided cathode layer, the conductive ink layer is surrounded by the conductive mesh structure, and then the conductive mesh structure is wound with the conductive wire to minimize resistance loss at the time of collecting electric charges in the length direction of the conductive mesh structure. Since the conductive wires, wound on the divided parts thereof, are connected to each other at the final end thereof, the moving distance of electric charges can be decreased, thus improving the efficiency of collecting electric charges.

Meanwhile, a method of manufacturing a tubular solid oxide fuel cell module according to the present invention includes the steps of: surrounding an outer surface of a fuel cell including a cathode layer divided into two parts or more with a conductive mesh structure; and winding the conductive mesh structure with a conductive wire.

Concretely, an electrolyte layer is formed on the outer surface of a tubular anode layer, a cathode layer is formed on the outer surface of the electrolyte layer such that the cathode layer is divided into two parts or more in a length direction, and then a conductive ink layer is applied onto the outer surface of the divided cathode layer. Thereafter, the conductive ink layer is surrounded by a conductive mesh structure whose inner surface is curved such that the inner surface of the conductive mesh structure corresponds to the outer surface of the conductive ink layer, and then a conductive wire is wound on the outer surface of the conductive mesh structure to fabricate a tubular solid oxide fuel cell module.

Further, after the conductive wire is wound on the conductive mesh structure, the conductive wire is fixed thereon using a jig or the like, and then sintered at a temperature of 800˜900° C. In the sintering temperature profile, a binder burns out at 500° C., and the sintering is conducted at 900° C.

As described above, the tubular solid oxide fuel cell module according to the present invention is advantageous in that a cathode is divided into two parts or more, unlike a conventional cathode, so that the moving distance of electric charges is decreased, with the result that resistance loss thereof can be minimized, thereby increasing the efficiency of collecting electric charges. Further, the tubular solid oxide fuel cell module according to the present invention is advantageous in that a conductive ink layer, a conductive mesh structure and a conductive wire are sequentially fixed on a tubular solid oxide fuel cell and then sintered to form a simple structure, and thus electric charges can be efficiently collected.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

Simple modifications, additions and substitutions of the present invention belong to the scope of the present invention, and the specific scope of the present invention will be clearly defined by the appended claims.

What is claimed is:

1. A tubular solid oxide fuel cell module, comprising:
a tubular anode layer;
an electrolyte layer formed on an outer surface of the tubular anode layer;
a cathode layer formed on an outer surface of the electrolyte layer and divided into two parts or more in a length direction thereof;
a conductive ink layer formed on an outer surface of the divided cathode layer;
a conductive mesh structure surrounding an outer surface of the conductive ink layer, the conductive mesh structure having a curved inner surface corresponding to the outer surface of the conductive ink layer; and
a conductive wire wound on an outer surface of the conductive mesh structure.

2. The tubular solid oxide fuel cell module according to claim 1, wherein the conductive mesh structure has 10˜80 meshes.

3. The tubular solid oxide fuel cell module according to claim 1, wherein the conductive wire is wound two times or three times per 1 cm length of the conductive mesh structure in a length direction of the conductive mesh structure.

4. The tubular solid oxide fuel cell module according to claim 1, wherein the conductive mesh structure is made of any one selected from the group consisting of Fe, Cu, Ag, Al, Ni, Cr, and alloys thereof.

5. The tubular solid oxide fuel cell module according to claim 1, wherein the conductive ink layer and the conductive wire are made of any one selected from the group consisting of Au, Pd, Ag, Pt, Ni, Ru, Rh, Ir, and alloys thereof.

6. A method of manufacturing a tubular solid oxide fuel cell module, comprising:
providing a tubular anode layer;
forming an electrolyte layer on an outer surface of the tubular anode layer;
forming a cathode layer divided into two parts or more in a length direction thereof on an outer surface of the electrolyte layer;
forming a conductive ink layer on an outer surface of the divided cathode layer;
forming a conductive mesh structure surrounding an outer surface of the conductive ink layer, the conductive mesh structure having a curved inner surface corresponding to the outer surface of the conductive ink layer; and
winding a conductive wire on an outer surface of the conductive mesh structure.

7. The method according to claim 6, further comprising: sintering the conductive wire after winding the conductive wire.

8. The method according to claim 7, wherein the sintering is conducted at 800˜900° C.

9. The method according to claim 6, wherein the conductive mesh structure has 10˜80 meshes.

10. The method according to claim 6, wherein the conductive wire is wound two times or three times per 1 cm length of the conductive mesh structure in a length direction of the conductive mesh structure.

11. The method according to claim 6, wherein the conductive mesh structure is made of any one selected from the group consisting of Fe, Cu, Ag, Al, Ni, Cr, and alloys thereof.

12. The method according to claim 6, wherein the conductive ink layer and the conductive wire are made of any one selected from the group consisting of Au, Pd, Ag, Pt, Ni, Ru, Rh, Ir, and alloys thereof.
